(19) United States
(12) Patent Application Publication
(10) Pub. No.: US 2008/0223014 A1
(43) Pub. Date: Sep. 18, 2008

(54) BI-FUNCTIONAL RAKE

(76) Inventor: Joel Robinson, Rancho Santa Margarita, CA (US)

Correspondence Address: MICHAEL RIES, 318 PARKER PLACE, OSWEGO, IL, 60543, US

(21) Appl. No.: 12/047,728

(22) Filed: Mar. 13, 2008

Related U.S. Application Data
(60) Provisional application No. 60/906,702, filed on Mar. 13, 2007.

(51) Int. Cl. A01D 7/06

(52) U.S. Cl. 56/400.16

(57) ABSTRACT

Disclosed is a garden rake and a leaf rake that is a single rake that combines a flexible leaf rake with a rigid bow rake. Attached to long handle is a metal fork that supports the traditional bow rake used for manipulating dirt, soil, rocks, debris or heavier organic material. Attached to the frame of the bow rake is a leaf rake, which is used to manipulate leaves, light debris or finer organic material.

This application claims priority to U.S. Provisional Application 60/906,702 filed 03-13-2007, the entire disclosure of which is incorporated by reference.

### TECHNICAL FIELD AND BACKGROUND

The present invention relates to a garden rake and a leaf/lawn rake. More specifically, the present invention is a single rake that combines a flexible leaf/lawn rake with a rigid bow rake. Attached to long handle is a metal fork that supports the traditional bow rake used for manipulating dirt, soil, rocks, debris or heavier organic material. Attached to the frame of the bow rake is a leaf rake, which is used to manipulate leaves, light debris or finer organic material.

This two-in-one design has been shown to help gardeners, who utilize both rake types, to use a single raking implement without the hassle and inconvenience of using two separate implements in tandem, saving time and energy. Research has indicated that this type of rake is particularly useful in desert regions to separate organic material, like weeds, from sand and rocks. Also, in areas with heavy leafing, the strength and rigidity of the bow rake makes it easier to move wet leaves and other heavier organic material. The rake has proven to help the raking efficiency for professional and recreational gardeners. Another advantage of the present invention is the savings of storage in a home where space is limited. The present invention provides a user with a single raking implement, having two raking functions, which can be used in combination to improve the efficiency of each raking function.

The present invention is a two-sided rake, dual rake or DuoRake also known as a bow/lawn rake or “Bola” rake. The present invention combines the utility of a lawn and bow rake into one implement. The present invention eliminates the need to switch back and forth to completely different tools, from bow to lawn rake while raking on varying surface environments. This is done by combining a lawn rake with a bow rake on one head and handle as one raking implement. The present invention has two distinct raking functions on one head and handle. The present invention is a lawn and bow rake on one head back-to-back able to employ one or the other by flipping the head 180 degrees with the handle. As a result of the design the rake has the ability to stand-up vertically on its own. The present invention method is to flip the two-sided head with the rake handle to employ either lawn rake or bow rake 180 degrees. The present invention can be used to rake on any surface environment, grass, rocks, sand, soil etc. as needed.

### BRIEF DESCRIPTION OF THE DRAWINGS

The objects, features, and advantages of the present invention will be apparent from the following detailed description of the preferred embodiment of the invention with references to the following drawings.

FIG. 1 is a view of a bi-functional rake in accordance with the present invention.

FIG. 2 is a view of a bi-functional rake in accordance with the present invention.

FIG. 3 is a view of a bi-functional rake in accordance with the present invention.

FIG. 4 is a view of a bi-functional rake in accordance with the present invention.

FIG. 5 is a view of a bi-functional rake in accordance with the present invention.

FIG. 6 is a view of a bi-functional rake in accordance with the present invention.

### DETAILED DESCRIPTION OF ILLUSTRATIVE EMBODIMENTS

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention, however, the order of description should not be construed as to imply that these operations are necessarily order dependent. In particular, these operations need not be performed in the order of presentation.

The phrase “in one embodiment” is used repeatedly. The phrase generally does not refer to the same embodiment, however, it may. The terms “comprising”, “having” and “including” are synonymous, unless the context dictates otherwise.

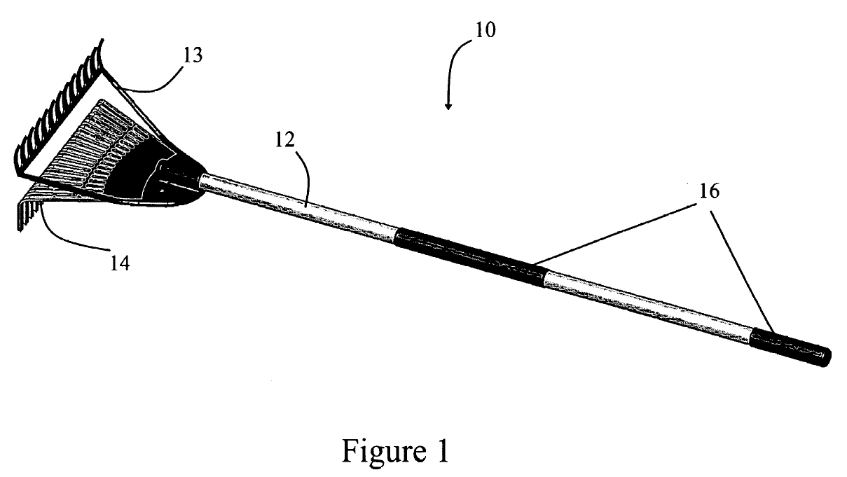

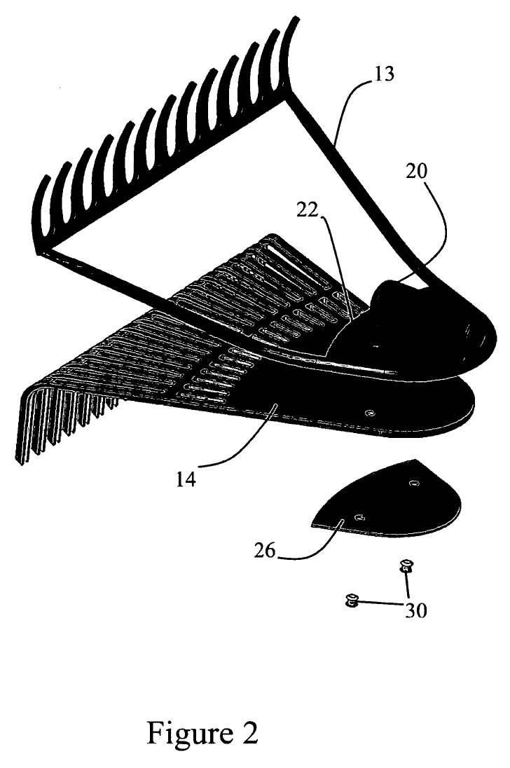

Referring to FIG. 1, as in one embodiment is a perspective view of a combo rake 10. Shown is a handle 12, a bow rake 13 and a flexible leaf rake 14. Also shown are grips 16 that may be glued to handle 12. Handle 12 may be a plutrusion handle. Referring to FIG. 2, as in one embodiment is a perspective view showing the flexible leaf rake 14 and a rigid bow rake 16. Shown are a handle attachment sleeve 20 on a bow plate 22 all that may both be welded to bow rake 13 and may be welded to each other. Attachment plate 26 accepts rivets 30 that are installed in rivet holes in the flexible leaf rake 14, the rigid bow rake 16 and the attachment plate 26. Handle attachment sleeve 20, bow plate 22, attachment plate 26 and bow rake 13 all may be made of black chrome plated steel. Flexible leaf rake 14 may be made of plastic.

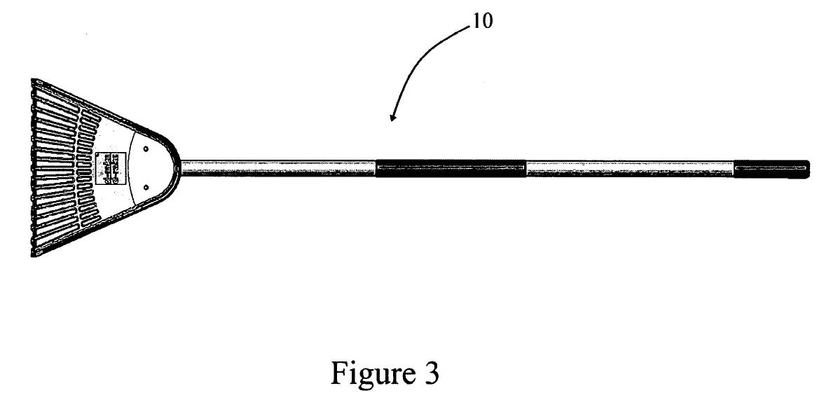

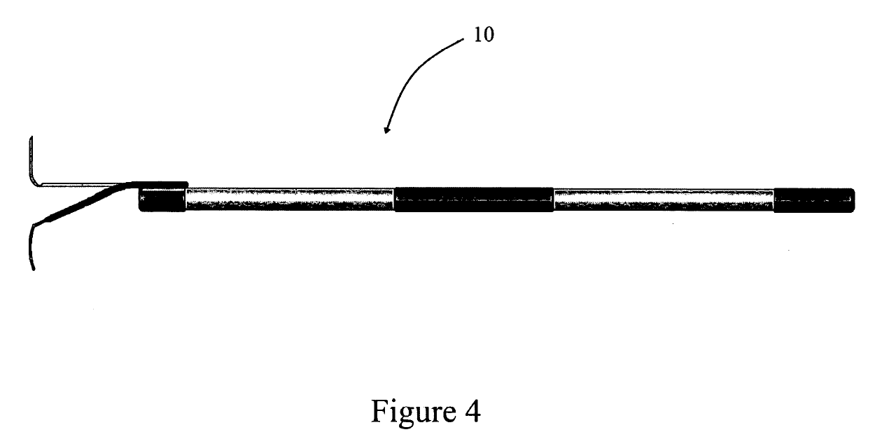

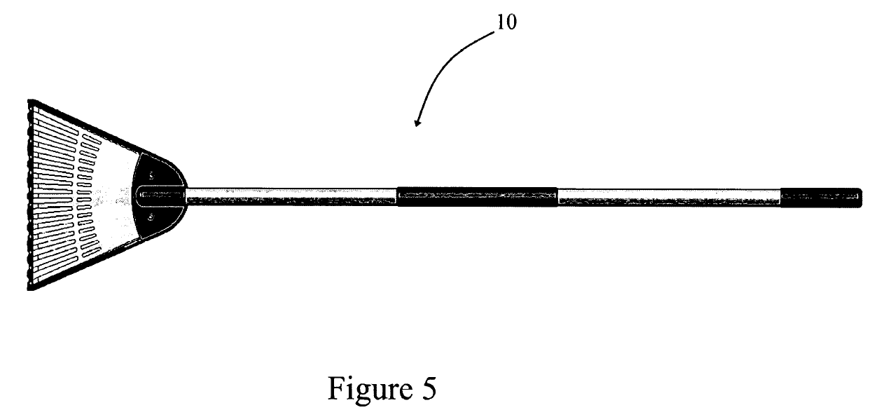

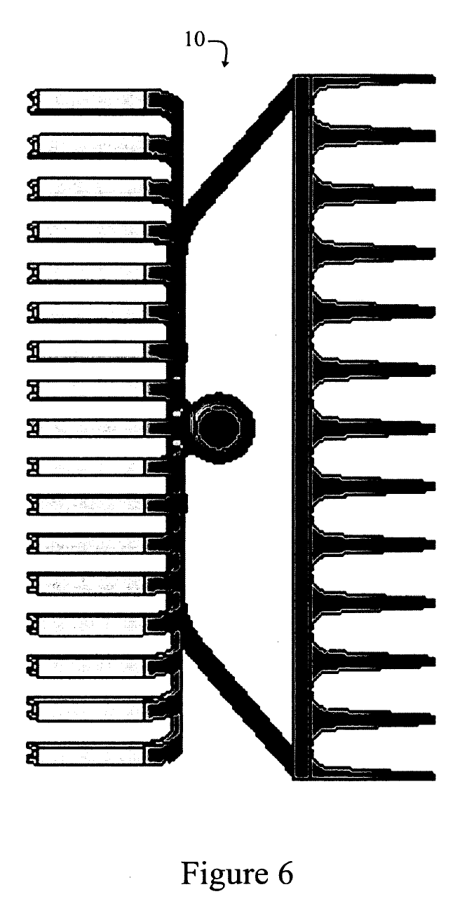

Referring to FIG. 3, as in one embodiment is a top view of combo rake 10. Referring to FIG. 4, as in one embodiment is a side view of combo rake 10. Referring to FIG. 5, as in one embodiment is a bottom view of combo rake 10. Referring to FIG. 6, as in one embodiment is an end view of combo rake 10.

While the present invention has been related in terms of the foregoing embodiments, those skilled in the art will recognize that the invention is not limited to the embodiments described. The present invention can be practiced with modification and alteration within the spirit and scope of the appended claims. Thus, the description is to be regarded as illustrative instead of restrictive on the present invention.

What is claimed is:

1. An combo rake comprising:
a handle with a bow rake and a flexible leaf rake attached to one end, the bow rake and the flexible leaf rake have teeth that oppose each other.

2. The combo rake of claim 1, wherein a handle attachment sleeve on a bow plate are connected to the bow rake, an attachment plate accepts rivets that are installed in rivet holes in the flexible leaf rake 14, the rigid bow rake 16 and the attachment plate 26.

3. The combo rake of claim 1, wherein the handle attachment sleeve, bow plate, attachment plate and bow rake are made of black chrome plated steel.

4. The combo rake of claim 1, wherein the flexible leaf rake may be made of plastic.

5. The combo rake of claim 1, wherein the bow rake and the flexible leaf rake each have teeth, the teeth on the bow rake and the flexible leaf rake are 180 degrees from each other.

6. A method comprising:
racking using a bow rake;
flipping the bow rake 180 degrees; and
raking with a flexible leaf rake, the flexible leaf rake attached to the bow rake.
